(19) United States
(12) Patent Application Publication
(10) Pub. No.: US 2020/0317437 A1
(43) Pub. Date: Oct. 8, 2020

(54) DISSOLVABLE PAPER PACKAGE FOR DELIVERY OF A FOOD PRODUCT

(71) Applicant: Nicholas J. Singer, Irvine, CA (US)

(72) Inventor: Nicholas J. Singer, Irvine, CA (US)

(21) Appl. No.: 16/813,641

(22) Filed: Mar. 9, 2020

Related U.S. Application Data
(60) Provisional application No. 62/831,058, filed on Apr. 8, 2019.
(60) Provisional application No. 62/867,084, filed on Jun. 26, 2019.
(60) Provisional application No. 62/978,757, filed on Feb. 19, 2020.

(51) Int. Cl. B65D 85/804; B65D 65/46; B65D 85/808; A47J 31/40; A23L 2/56; A23L 2/66; A23L 2/52

(52) U.S. Cl. CPC B65D 85/8043; B65D 65/463; B65D 85/808; A23V 2002/00; A23L 2/56; A23L 2/66; A23L 2/52; A47J 31/40

(57) ABSTRACT

A dissolvable or partially dissolvable package is disclosed, which comprises a dissolvable, consumable material that minimizes clean-up and trash typically generated by packages that contain consumable materials. The package is typically used to deliver consumable materials to a consumable beverage, such as hot or cold water, juice, milk, or alcohol, to create a consumable beverage containing the consumable material. The package could be placed in the beverage itself, or in a machine that disperses liquid that dissolves the package and delivers the mixture of the liquid, the package, and the package contents to a beverage container. Dissolvable, consumable, logos could also be printed on the package, where the logo dissolves at a slower rate than the package, to provide a dissolvable, consumable logo that floats on the beverage as the main body and contents of the package dissolve into a beverage.

### CROSS-REFERENCE TO RELATED APPLICATIONS

This application claims the benefit of priority to U.S. Patent Provisional Application No. 62/831,058, filed Apr. 8, 2019, U.S. Patent Provisional Application No. 62/867,084, filed Jun. 26, 2019, and U.S. Patent Provisional Application No. 62/978,757, filed Feb. 19, 2020, the entire contents of which are expressly incorporated herein by reference.

### STATEMENT RE: FEDERALLY SPONSORED RESEARCH/DEVELOPMENT

Not Applicable

### TECHNICAL FIELD

This application relates to edible product systems and methods.

### BACKGROUND

There are many food and beverage products that are provided to customers in disposable package containers to allow a customer to easily and quickly create consumable food or beverages. For example, instant coffee could be provided in a disposable package to allow a customer to create a coffee beverage by combining dissolvable coffee grounds in water, and sugar granules could be provided in a disposable package to allow a customer to add sugar to a beverage. Such products, however, create waste which can be inconvenient for customers who are in a hurry. In addition, transferring food and/or beverage products from a disposable packet to a container can sometimes create a mess—particularly if the product is in liquid form.

Accordingly, there is a need in the art for an apparatus and method to allow consumers to consumers to consume food products quicker and easier which is not prone to creating trash.

### BRIEF SUMMARY

A package for preparing a beverage is disclosed, which is designed to allow consumers to consume food products quicker and easier without creating the trash that is indicative of typical packages that contain consumable materials. The package is generally made from dissolvable, consumable products that dissolve when placed in a liquid, and are safe for human consumption. The dissolvable, consumable products comprising the package could also be designed to dissolve at different rates, allowing for embodiments that allow a liquid to enter and dissolve the contents of a first enclosed interior cavity of the package before entering and dissolving the contents of a second enclosed interior cavity of the package. In some embodiments, the package could be placed in a machine that dispenses liquid about the package, allowing the liquid to dissolve the package and mix with the consumable materials before the mixed beverage is then deposited within a beverage container. Such embodiments would minimize post-beverage-delivery clean-up of the machine as a majority of the package and package contents would dissolve into the beverage. Dissolvable, consumable logos could also be printed on a surface of the package, where the logo is designed to dissolve at a slower rate than a bottom sheet of the package, allowing for the logo to float on a beverage surface as the consumable materials of the package are dissolved/dispersed into the beverage.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1A is a front plan view of an embodiment of a package;

FIG. 1B is a cross-sectional top-side view of the package shown in FIG. 1A;

FIG. 1C is a cross-sectional right-side view of the package shown in FIG. 1A;

FIG. 2A is a front plan view of a dissolvable, edible, paper used to create a package;

FIG. 2B is a cross-sectional side view of the paper of FIG. 2A;

FIG. 3A is a front plan view of another embodiment of a package;

FIG. 3B is a side plan view of the package shown in FIG. 3A;

FIG. 4 is a front perspective view of another embodiment of a package;

FIG. 5 is a top perspective view of another embodiment of a package;

FIG. 6 is a front perspective view of another embodiment of a package;

FIG. 7A is a front perspective view of an embodiment of a package-holder;

FIG. 7B is a front perspective view of the package-holder shown in FIG. 5A, in an open position;

FIG. 7C is a front perspective view of the package-holder shown in FIG. 5A with the package shown in FIG. 3A;

FIG. 8A is a front perspective view of another embodiment of a package-holder;

FIG. 8B is a top perspective view of the package-holder shown in FIG. 8A;

FIG. 9A is a front perspective view of the package-holder shown in FIG. 6A in an open position with the package shown in FIG. 4;

FIG. 9B is a front perspective view of the package-holder and package shown in FIG. 9A with the package placed further within the receptacle of the package-holder;

FIG. 10A is a front perspective view of the package-holder shown in FIG. 8A with the package shown in FIG. 6;

FIG. 10B is a front perspective view of the package-holder shown in FIG. 10A with the package placed further within the receptacle of the package-holder;

FIG. 10C is a front perspective view of the package-holder shown in FIG. 10A with the package placed even further within the receptacle of the package-holder;

FIG. 11A is a front perspective view of a machine that accepts the package-holder shown in FIG. 5A;

FIG. 11B is a front perspective view of the machine shown in FIG. 7A dispending a drink;

FIG. 12A is a front perspective view of the package-holder shown in FIG. 7A with the package shown in FIG. 3A;

FIG. 12B is a cross-sectional front plan view of the package-holder and package shown in FIG. 12A with a beverage being dispensed on the package;

FIG. 12C is a cross-sectional plan view of the package-holder and package shown in FIG. 12A with a beverage being dispensed on the package after a period of time has passed;

FIG. 13A is a front perspective view of the package-holder shown in FIG. 8A with the package shown in FIG. 5;

FIG. 13B is a cross-sectional front plan view of the package-holder and package shown in FIG. 13A with a beverage being dispensed on the package;

FIG. 13C is a cross-sectional plan view of the package-holder and package shown in FIG. 13A with a beverage being dispensed on the package after a period of time has passed;

FIG. 14A is a front perspective view of the package-holder shown in FIG. 8A with the package shown in FIG. 6;

FIG. 14B is a cross-sectional front plan view of the package-holder and package shown in FIG. 14A with a beverage being dispensed on the package; and

FIG. 14C is a cross-sectional plan view of the package-holder and package shown in FIG. 14A with a beverage being dispensed on the package after a period of time has passed.

FIG. 15A is a front perspective view of a package having a consumable, dissolvable logo printed on a surface of the package and a beverage container holding a beverage.

FIG. 15B is a front, perspective view of the beverage container of FIG. 15A with the package placed on top of the beverage.

FIG. 15C is a top, perspective view of the beverage container of FIG. 15A with a body of the package of dissolved and the logo floating on top of the beverage.

FIG. 15D is a top, perspective view of the beverage container of FIG. 15A with a spoon used to help accelerate the dissolving process of the logo.

FIG. 15E is a top, perspective view of the beverage container of FIG. 15B with the entire package and logo dissolved in the beverage.

### DETAILED DESCRIPTION

The various embodiments and aspects described herein relate to a dissolvable or a partially dissolvable package, such as package 100, 300, 400, 500, or 600, that can be combined with a serving of consumable liquid, such as hot or cold water, juice, milk, or alcohol, for making a consumable beverage. As used herein, a material that is dissolvable comprises a material having bonds, wherein a majority (at least 80, 85, 90, or 95%) of the bonds liquefy or disperse relative to one another when placed within a neutral liquid, such as water, over a period of time, such as within 5 seconds, 20 seconds, 30 seconds, 1 minute, 5 minutes, 10 minutes, or even within an hour in some embodiments. Exemplary dissolvable, edible, materials include rice paper, cellulose paper, wood pulp, carboxymethyl cellulose, and/or sodium carbonate. Preferred dissolvable materials are water-soluble and have a pH of about 7, plus or minus half of a pH level. As used herein, a material that is partially dissolvable comprises a material having a volume and bonds holding together the material, wherein the bonds liquefy or disperse relative to one another when placed within a neutral liquid, such that the largest intact portion of the material is at most 5% of a volume of the material before the material is placed within the neutral liquid. Exemplary partially dissolvable materials include non-dissolvable materials held together by dissolvable adhesives or paper. As used herein, dispersible materials comprise non-dissolvable solids or slow-dissolving solids (solids that require submersion within a liquid for more than an hour or more to dissolve) that disperse from one another when placed in a liquid. Exemplary dispersible materials comprise tea leaves, rice balls, and hard candy. As used herein, a material that is edible, drinkable, or consumable comprises a material that is non-toxic when consumed by a human person where the consumed material is in any amount below fifty grams of weight. Exemplary edible materials include food and dietary supplements or even prescription drugs. Preferably, every element of the package, from the dissolvable materials that make up the solid walls of the packaging, the adhesives that hold the materials together, and the materials within the package are edible and/or food grade.

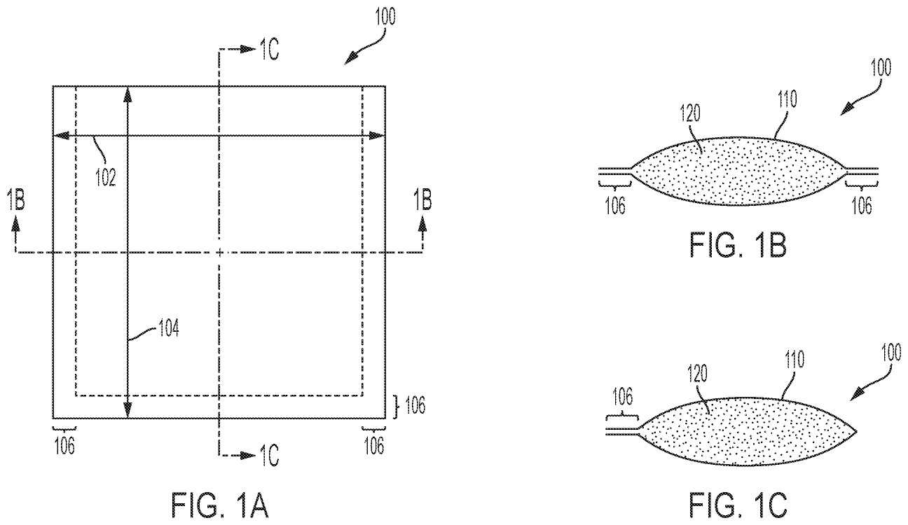

Referring now to the drawings, package 100 is shown in FIGS. 1A-1C. In FIG. 1A, package 100 is shown as a rectangular-shaped package having a width 102 and a length 104, however, any suitable shape could be used, for example circles, pentagons, hexagons, ovals, parallelograms, or symmetrical or non-symmetrical combinations thereof. By way of example and not limitation, package 100 may be shaped as elongate tube with a fin seal along its longitudinal length and end seals on opposed end portions of the elongate shaped package. By way of example not limitation, the outer diameter of the elongated package may be less than 1 inch, and preferably less than 0.5 inches in length. For dissolvable packages of other configurations, such as the rectangular-shaped dissolvable package as shown in FIG. 1A, the length and the width 12, 14 of package 10 may be less than about 3 inches by 3 inches and is preferably less than 1.5 inches by 1.5 inches. Such dissolvable packages could have sides of substantially identical length, or sides of different length. Such dissolvable packages could be dropped into a beverage container, such as a cup containing hot or cold water, to create a consumable mixed drink. Contemplated dissolvable packages are also disclosed in co-pending application Ser. No. 16/156,970 filed Oct. 10, 2018 titled SINGLE-SERVE FORMED SOLUBLE COFFEE PRODUCT, which is incorporated herein by reference.

Package 100 may be wrapped in a sanitary package, such as a liquid-impermeable film container (not shown) comprising plastic, which may contain one or more dissolvable packages. A user could remove package 100 from the impermeable film container prior to submersing the package 100 into the beverage, for example either by placing package 100 into a mouth of a bottle or by placing it within a cup containing a beverage. Package 100 could comprise a dissolvable, edible, paper 110 which encapsulates a consumable material 120—ensuring that 100% of the materials of package 100 is consumable. The dissolvable, edible, paper 110 and the consumable material 120 may both be edible (or food-grade) in that a human being can consume the dissolvable, edible, paper 110 and the consumable material 120 without harming the human being. By way of example non limitation, the dissolvable, edible, paper 110 and the consumable material could comprise any material approved by the Food and Drug Administration (FDA) for consumption by human beings, or any material compliant with any regulatory authority (FDA or otherwise) regarding human consumption.

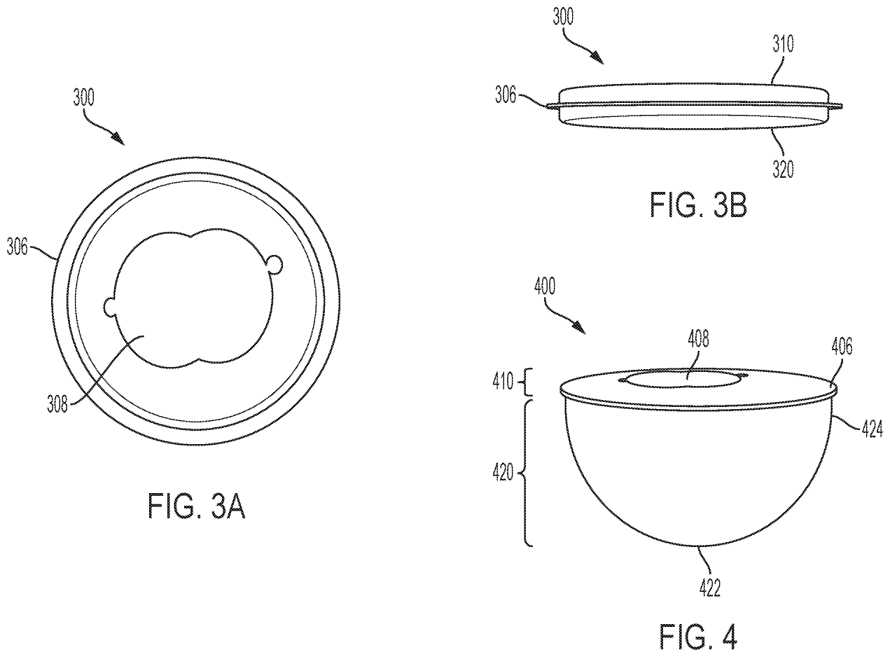

Referring now to FIGS. 3 and 4, dissolvable, edible, paper 110 may include a dissolvable sheet 112 and a dissolvable adhesive 114. As previously discussed, dissolvable materials are preferably also edible. As such, the adhesive could comprise any dissolvable, edible, adhesive, such as pullulan, cellulose, propylene glycol, polyvinyl alcohol, and cellulose gum. Preferably, both dissolvable sheet 112 and dissolvable adhesive 114 are edible. The dissolvable, edible, paper 110 could be provided in any suitable manner, for example in sheet form or in a roll form, for ease of construction of a dissolvable packet, such as dissolvable packet 100. When the dissolvable, edible, paper 110 is provided in a sheet form, the size of the sheet 112 may be configured and sized such that the dissolvable, edible, paper 110 may be folded up and sealed into a suitable shape for a packet, such as an elongated package shape or a rectangular/square package shape. When the dissolvable, edible, paper 110 is provided in a roll form, the package 100 could be fabricated using a tube-filling machine that creates a fin seal along a longitudinal length of the tube along a length of package 100 having opposing end fin seals that closes ends of package 100.

The sheet could be fabricated from a paper material and be dissolvable in a liquid (e.g., water). For example, the sheet could be a dissolvable sheet, such as those disclosed in U.S. Pat. Nos. 8,802,591, 7,514,262, 6,845,982, 6,828,018 and U.S. Patent Publication No. 2014/0010989, all of which are incorporated here by reference. The liquid may preferably be a consumable or edible beverage, such as water or juice. Whatever the liquid, the dissolvable, edible packet comprises a material that is soluble for a liquid that it is designed for, and preferably every element of the packet, from the walls to the adhesives used to the contents of the packet, are all edible for human consumption.

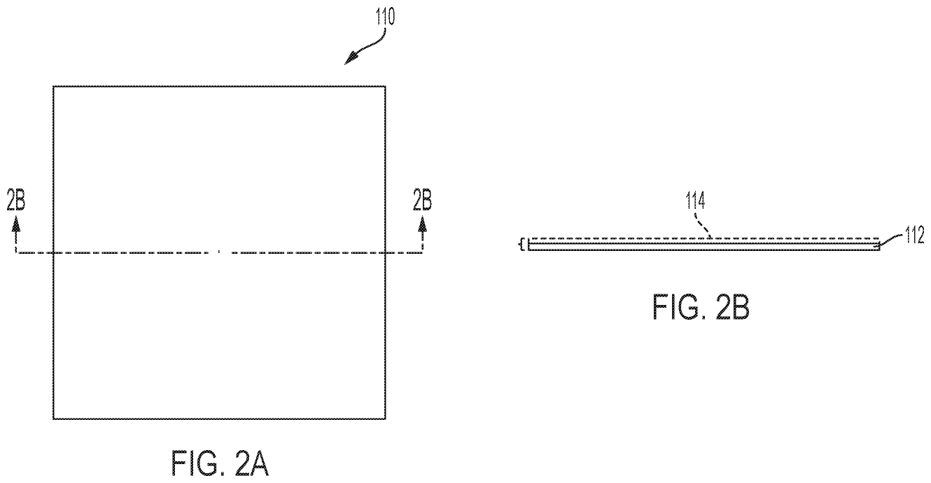

As stated above, the dissolvable, edible, paper preferably includes a dissolvable adhesive, such as adhesive 114, used to affix the paper to another dissolvable or dispersible object, or to itself. The adhesive is preferably an edible (food grade) adhesive compliant with regulations (e.g. FDA regulations) for human consumption. The adhesive could be coated on an entire side of sheet 110, such as shown in FIG. 2B as adhesive layer 114. Alternatively, the adhesive may be applied to only a portion of a surface of sheet 110 for the purposes of folding and/or sealing the sheet only in those areas to form package 100. In some embodiments, the adhesive could be heat or light activated, allowing for the adhesive to be inert during transport at room temperature, and active when a stimulus is applied, such as heat or light, as the case may be.

By way of example and not limitation, as shown in FIGS. 1 and 2, paper 110 could be folded in half and at least three peripheral edge portions of the package 100 could be adhered to each other, for example using a fin seal. The edges that are adhered to another edge are represented by broken line in FIG. 1. FIG. 1 illustrates a package 100 having a rectangular or square configuration. The dissolvable, edible, paper 110 could be folded with consumable material 120 disposed between the folded portions of the dissolvable, edible, paper 110. In embodiments where adhesive 114 is heat or light-activated, heat or light may be applied to at least some of the peripheral edge portions 106 to seal consumable material 120 between portions of dissolvable, edible, paper 110. The adhesive layer 114 could be spread or coated on an entire inside surface of sheet 112, or in the alternative, could be applied to only spot areas represented by the peripheral edge portions 106. The adhesive could be activated in any suitable manner, for example by using heat, light, or some other activating agent, such as an activating liquid that reacts with adhesive layer 114. Such activating liquids preferably comprise a liquid that does not dissolve the sheet 112.

Consumable material 120 could be any edible material, such as coffee, protein, additives, tea leaves, flavors, preservatives, and/or moisture absorbent materials. However, package 100 and anything placed within it is preferably an edible, food-grade material ingestible by a human being. Preferably, the pH of the material is close to 7, within 0.5 of a pH level. In embodiments where consumable material 120 comprises a coffee, the coffee could comprise a dissolvable coffee. The consumable material (e.g. coffee, protein) could be provided in a granular form (e.g. less than ¼ inch in diameter) or solid form (e.g., greater than ¼ inch in diameter), and may be dissolvable (majority of solid bonds liquefy), partially dissolvable (minority of solid bonds liquefy), or dispersible (disperse into liquid to increase a distance from one another). All of the consumable material 120 may be provided in a powder, granular, or a solid form of any suitable size.

An alternative package 300 is shown in FIGS. 3A-3B, comprising two dissolvable, edible, papers 310 and 320, similar to dissolvable, edible, paper 110, sized and disposed to be substantially elliptical or circular. Papers 310 and 320 have dimensions that are substantially mirror images of one another, allowing the edges to match up when placed side-by-side with one another, to form fin seal 306 around a periphery of package 300 when the adhesive sides (not shown) of each of dissolvable, edible, papers 310 and 320 are coupled to one another using the dissolvable, edible adhesive. Fin seal 306 seals a consumable material (not shown) within the boundaries of dissolvable, edible, papers 310 and 320, allowing package 300 to hold an edible material for ease of dispensing into a beverage by tossing package 300 into the beverage. While a fin seal 306 is shown in FIG. 3, any suitable seal could be used, such as an embedded seal without a projection or a recessed seal. As used herein, a “seal” comprises an attachment mechanism between two materials that forms an air-tight, liquid-tight, or solid-tight seal between the two materials, preferably using a dissolvable, edible, food-grade adhesive.

A logo 308 could be printed on dissolvable, edible, paper 310, allowing a user to brand the paper with any suitable information related to the edible material contained within package 300, such as a label indicating the consumable material within, or a logo indicating a brand that provides the consumable material. While dissolvable, edible, papers 310 and 320 are shown as substantially elliptical or circular, dissolvable, edible, papers could comprise any suitable shape, for example rectangular, pentagonal, hexagonal, semi-circular, or even irregular (e.g. snake-shaped or shaped like one or more alphanumeric characters). Logo 308 could comprise an ink that dissolves or disperses when placed within a liquid, such as water, coffee, or juice. In some embodiments, logo 308 comprises an edible substance, such as sugar or frosting, that is printed on dissolvable, edible, paper 310 and does not dissolve or disperse when placed within a liquid, allowing the logo to float on top of a surface of the liquid or sink within the liquid in substantially one piece.

In some embodiments, logo 308 could be printed by a user of dissolvable, edible, paper 310, for example by a barista who purchases dissolvable packet 300. In such embodiments, the barista could print the logo onto a dissolvable, edible paper, such as either of paper 310 or 320, using mechanical tools, such as a frosting dispenser, or could download a 3-D printing file from a database made available to the barista, which could then be fed into a food 3-D printer to print logo or design 308 onto dissolvable, edible, paper 310. In this way, custom designs could be made that could float on a beverage after dissolvable packet 300 is dissolved within a beverage. In some embodiments a QR code could be printed on a top of a container (not shown) for package 300, which, when scanned by a scanning device, directs a computing device functionally coupled to the scanning device to a database having such custom designs for the package in the container.

An alternative package 400 is shown in FIG. 4, comprising two dissolvable, edible, papers 410 and 420. Contrary to package 300, the dissolvable, edible, papers 410 and 420 comprise dimensions that are not substantially identical, allowing a pocket formed within the walls of dissolvable, edible, paper 420 to hold more consumable material than dissolvable, edible, paper 410. Here, the width of upper section 424 of dissolvable, edible, paper 420 tapers towards a lower section point 422 of dissolvable, edible, paper 422 to form a cavity within which consumable material (not shown) could be stored. While dissolvable, edible, paper 420 forms a dome-shaped exterior with a corresponding cavity, dissolvable, edible, paper 420 could form a cavity of any suitable shape to hold consumable material, for example a prism (e.g. rectangular, triangular, cylindrical), a die (six-sided, eight-sided, twenty-sided), or a pyramid. While dissolvable, edible, paper 420 is shown having a cavity to hold consumable material while dissolvable, edible, paper 410 comprises a largely two-dimensional surface without a cavity used to cover an egress of the cavity, dissolvable 410 could also comprise a cavity in some embodiments, similar to dissolvable, edible, paper 310 in FIG. 3B. Dissolvable, edible, paper 410 has a dissolvable ink 408 that is printed on a surface of dissolvable, edible, paper 410. While package 400 comprises a lip 406 having a circumference at a widest point of package 400, package 400 could be sized and disposed to be without a lip to provide a smoother look and feel.

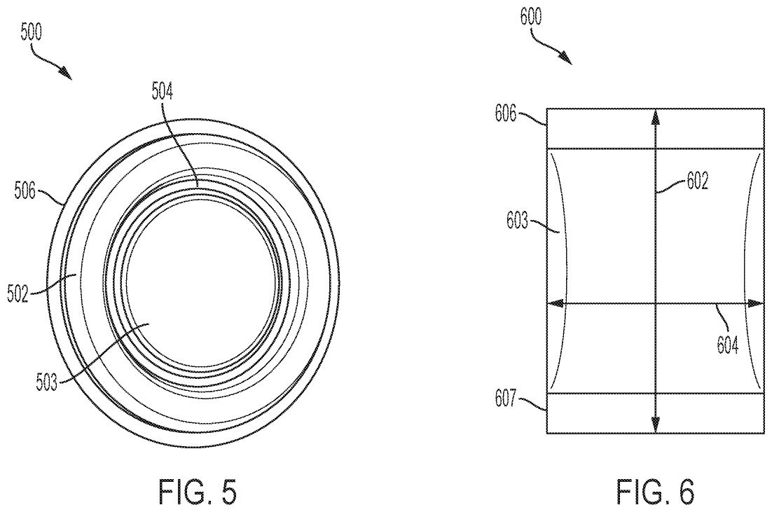

An alternative package 500 is shown in FIG. 5, also comprising two dissolvable, edible, papers similar to package 300, however having two seals 504 and 506. Seal 504 comprises a seal between package section 502 and package section 503, while seal 506 comprises a fin seal that seals off package section 502 from an exterior surface of alternative package 500. Package section 502 and package section 503 preferably hold different consumable materials from one another, for example package section 502 could comprise dissolvable coffee grounds while package section 503 could comprise dissolvable powdered milk, or package section 503 could comprise dissolvable hot chocolate while package section 502 could comprise cream powder. In some embodiments, portions of a wall of a package section could be disposed to be thicker or thinner than other walls of alternative package 500 to encourage submersion of one consumable material in one package section before submersion of another consumable material in another package section. For example, a portion of a wall of a package section (e.g. section 503) holding dissolvable coffee grounds could be designed to be thinner, or to be made of a material that dissolves at a faster rate, than a portion of a wall of a package section (e.g. section 502) holding powdered milk. This way, the beverage will have coffee mixed into the beverage before the powdered milk is mixed into the beverage. In some embodiments, a first package section could be configured to have a greater exposed surface area than a second package section, which would also encourage a portion of the wall of the first package section to dissolve before a portion of the wall of the second package section dissolves.

While package 500 is shown to have two package sections divided by a seal, more or less package sections could be formed in other embodiments. In some embodiments, the package could be shaped in a substantially linear fashion, dividing package sections into segments that can be cut or ripped (e.g. along a perforation line). In such embodiments, each package section could comprise same or different consumable materials, or could comprise repeating different materials (e.g. coffee grounds then powdered milk then coffee grounds then powdered milk).

Yet another alternative package 600 is shown in FIG. 6, comprising upper and lower fin seals 606 and 607, respectively, sealing package section 603 from an exterior surface of alternative package 600. Alternative package 600 comprises a dissolvable, edible, paper similar to paper 110 that overlays itself to create a cylinder having a height 602 and a width 604, and the two open edges at the top and bottom of the cylinder are then sealed after a consumable material is placed within the cylinder and the cylinder is then flattened into a substantially rectangular shape. In some embodiments, a manufacturer could choose not to flatten the cylinder, allowing package 600 to retain a substantially cylindrical shape. Here, the dimensions of height 602 and width 604 of package 600 are configured to be substantially rectangular, however, the width 604 could be configured to be less than ½, ⅓, ⅕, or even ⅛ the height 602 to create a more cylindrical look. Such cylinders could be used to deposit package 600 in a neck of a water bottle.

Any of dissolvable packages 100, 300, 400, 500, or 600 could be filled with consumable material in any suitable manner, for example with a tube-filling machine, a package-filling machine, or by hand. In preferred embodiments, the dissolvable, edible, paper used, such as dissolvable, edible, paper 110, is configured to be less than 2 mm, 1 mm, 0.5 mm, or even 0.25 mm thick, so as to be sized to fit between the rollers of a configured fin seal machine, such as the fin seal machine disclosed in U.S. 2019/0029291, which is incorporated by reference herein. The machine preferably accepts a dissolvable, edible, paper sheet 112, coats at least a portion of one side of the dissolvable sheet 112 with a dissolvable adhesive, such as dissolvable adhesive 114, folds the dissolvable, edible, paper sheet about a consumable material, activates the dissolvable adhesive, and then applies pressure to both sides of the sheet about the dissolvable adhesive to seal the consumable material within the sheet. In other embodiments, two pieces of dissolvable, edible, paper, such as dissolvable, edible, paper 310 and 320, are pre-treated with dissolvable adhesive before being fed into a machine, and are then placed around a consumable material, before having a pressure applied to the non-adhesive sides of the papers to form a seal, such as fin seal 306. In other embodiments, the machine could accept a flat sheet and could shape the sheet into a pocket, such as the pocket in dissolvable, edible, paper 420, and the machine could then deposit consumable material in the pocket before covering the opening of the pocket with dissolvable, edible, paper 410, which is then sealed to the surface of dissolvable, edible, paper 420 using a suitable dissolvable adhesives. Any suitable method could be used to form each of dissolvable packages 110, 300, 400, 500, and/or 600.

Additionally, any of dissolvable packages 100, 300, 400, 500, or 600 could be used to conveniently deposit consumable material in a container having a liquid beverage, such as water or juice, or coffee. If the package is provided as an elongated shaped package, such as package 600 (having a longer height 602 than width 604), then a user could mix a drink quickly by playing the elongated package 600 in a disposable water bottle. The package 600 could be configured to have a width 604 less than 1 inch or ½ inch, allowing the package 600 to be easily placed within a small mouth opening have a small mouth opening (e.g., having a diameter less than or equal to 1 inch) of the disposable water bottle. The user could remove a cap from the mouth of the water bottle. The user could remove (e.g., spill out or drink) some water from the water bottle to make room for the package 600 and the consumable material within package section 603. The user could slip the elongate package 600 through the mouth of the disposable water bottle after removing the small amount of water sufficient so that after the elongate package 600 is slipped into the water bottle, the water does not spill out of the mouth. The user could then close the water bottle with the cap, shake the water bottle to form a consumable mixed drink within the disposable water bottle. By way of example, not limitation, the package 600 could be filled with protein powder and, following the steps above, the user could form a mix drink of protein powder quickly since the water-soluble paper is dissolvable (preferably, the water-soluble paper is dissolvable in water under 30 seconds). The consumable material within the package section 603 could be mixed into water either homogeneously or heterogeneously. In the case of protein powder, the protein powder may be the consumable material and the mixed drink may be a nutritious protein powder drink. Alternatively, the consumable material may be dissolvable coffee. It is contemplated that the package may be provided as a square shaped package which may be dropped into a hot cup of water. Such a method could be used form a cup of coffee.

The beverage in which any of dissolvable packages 100, 300, 400, 500, or 600 is dropped in could have a temperature between 33 degrees Fahrenheit to 220 degrees Fahrenheit. By way of example, the beverage could comprise hot water that has a temperature between 130 degrees Fahrenheit to 180 degrees Fahrenheit and the package could contain dissolvable coffee. When the package with dissolvable coffee is dropped into a hot cup of water, the water-soluble paper dissolves and the dissolvable coffee is dispersed into the hot water to make a cup of hot coffee. In some embodiments, the beverage could be a hot coffee, and the package could contain an additive, such as powdered milk or sugar, which could then be tossed into the container with the hot coffee to dispense the additive in the beverage.

In some embodiments, a machine could be used to dispense a mixed beverage using an inventive dissolvable package comprising a consumable material. Such machines preferably have a package holder that is used to hold the package and mix the beverage while it is poured into a beverage container.

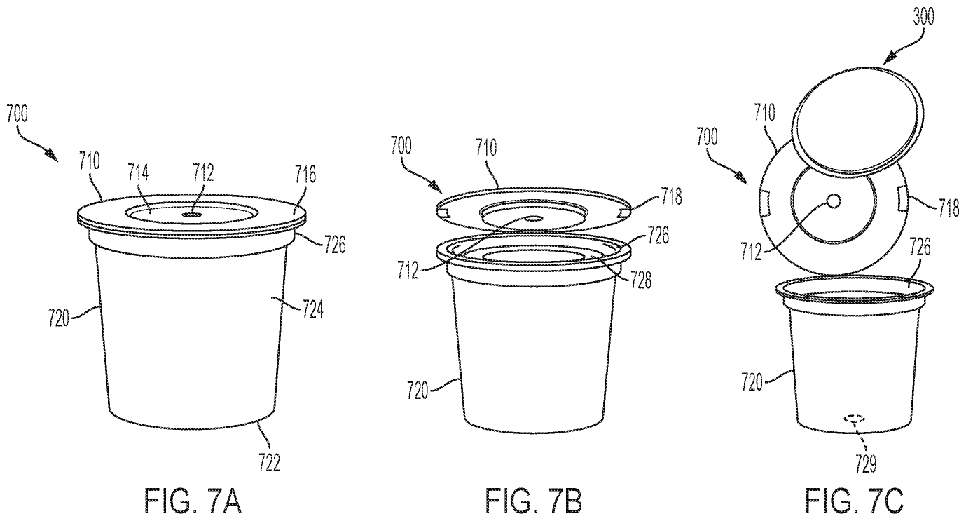

An exemplary package holder 700 is shown in FIGS. 7A-7C, having a repository 720 and a cover 710. Cover 710 could be sized and disposed to snap-fit using projections 718 that mate with recesses formed within upper reservoir 726. Cover 710 has a hole 712 through which a liquid beverage could be poured, such as water, coffee, tea, milk, or any other consumable, food-grade beverage. Package holder 700 is sized and disposed to hold a package that is circular or elliptical, such as package 100, package 300, or package 400, each of which has an upper lip (peripheral edge portions 106, fin seal 306, or lip 406, respectively), which is sized and disposed to rest on an upper shoulder 728 in between upper reservoir 726 and lower reservoir 724. The consumable beverage could dissolve or disperse at least a portion of the exterior wall of the dissolvable packet, mix with the consumable materials within repository 720, and exit via mixed beverage outlet 729 along the bottom side of repository 720.

Package holder 700 could be configured for a machine and a package used with package holder 700. For example, the location of upper shoulder 728 could be adjusted to accommodate a pouring rate of the machine within which package holder 700 is placed and the dissolving rate of the package that is placed within package holder 700. For example, package that dissolves at a slower rate may necessitate a lower shoulder 728 than a package that dissolves at a higher rate, since a beverage will need to rest within upper reservoir 726 for a longer period of time before the package dissolves. In another example, a machine that pours at a faster rate may also necessitate a lower shoulder 728 than a machine that pours at a slower rate, as the upper reservoir 726 will tend to fill up faster when used in a machine that pours at a faster rate. Preferably, package holder 700 and the package used within package holder 700 are configured to allow a beverage to dissolves through the package and into lower reservoir 724 before upper reservoir 726 fills up at the pouring rate of the machine used.

In FIG. 7C, package 300 is shown as being placed within package holder 700, although any circular package, such as package 100 or package 400, could be used. Other packages that are not sized to fit within the walls of package holder 700 could be used in some embodiments, but where a package is too large, a user would need to fold or crunch portions of the package to fit within reservoir 700, and where a package is too small, the package would not be able to be held up on shoulder 728. In some embodiments, ridges, projections, or recesses could be shaped along the walls of lower reservoir 724 to improve a rotation of a beverage being placed within reservoir 700, for example rotational projections used within wind turbines.

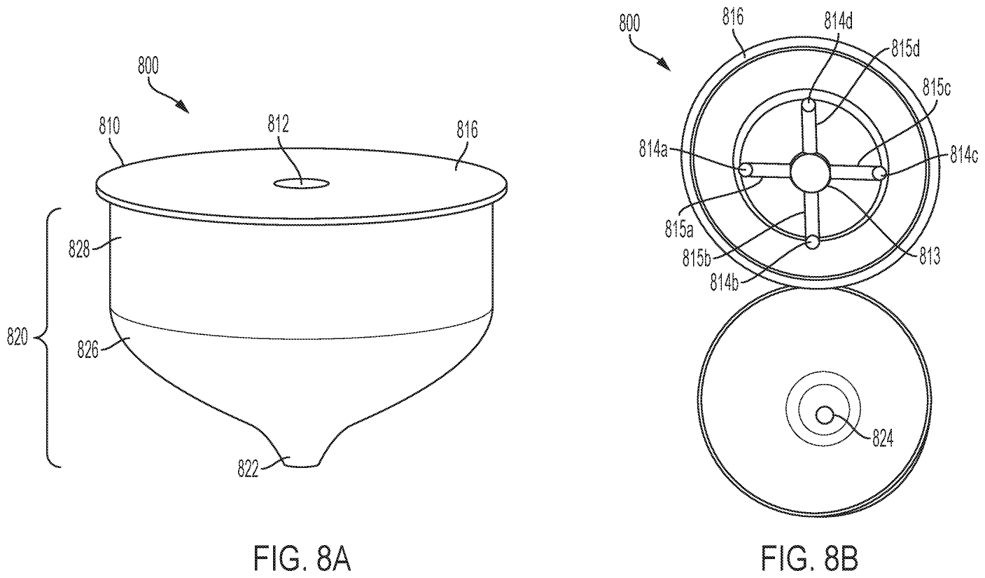

An alternative package holder 800 is shown in FIGS. 8A and 8B. Package holder 800 is substantially nut-shaped, having a cover 810 and reservoir 820. Cover 810 is rotatably coupled to a top edge of reservoir 820 via any suitable coupling means. In preferred embodiments, cover 810 and reservoir 820 are molded as a single thermoplastic material having a melting point above 200 or 300 degrees so as to withstand hot beverages being poured within package holder 800, with a thinner piece of plastic rotatably coupling cover 810 and reservoir 820 when molded. Cover 810 has a single upper inlet port 812 and four lower outlet ports 814a, 814b, 814c, and 814d, which connect to upper inlet port 812 via manifold 813 and fluid passageways 815a, 815b, 815c, and 815d, respectively. While each fluid passageway is shown as straight to allow for the beverage to be poured into reservoir 820 in four substantially cardinal directions, the fluid passageways 815a, 815b, 815c, and 815d could be curved to encourage a whirlpool effect when the beverage is dispensed into reservoir 820.

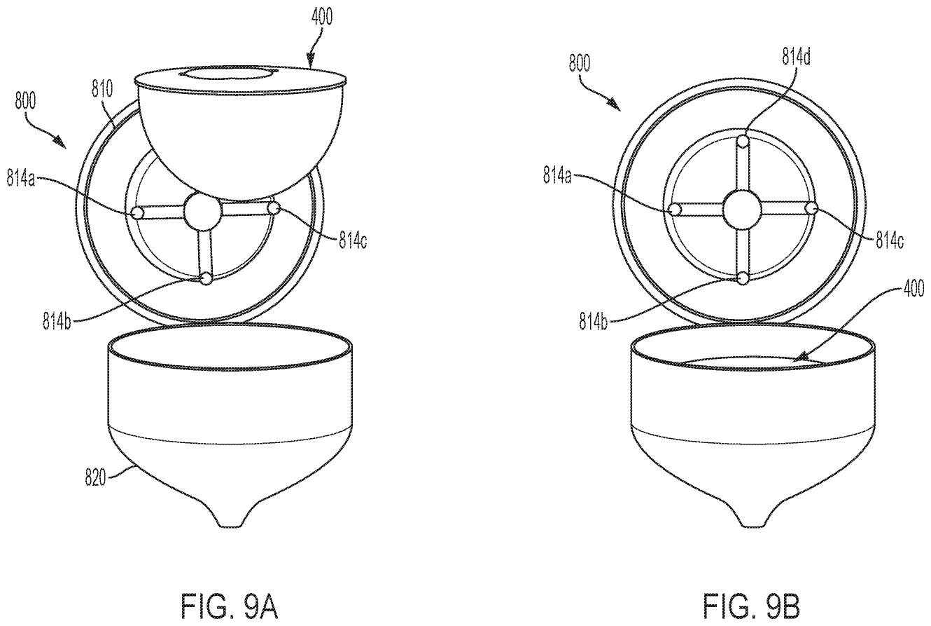

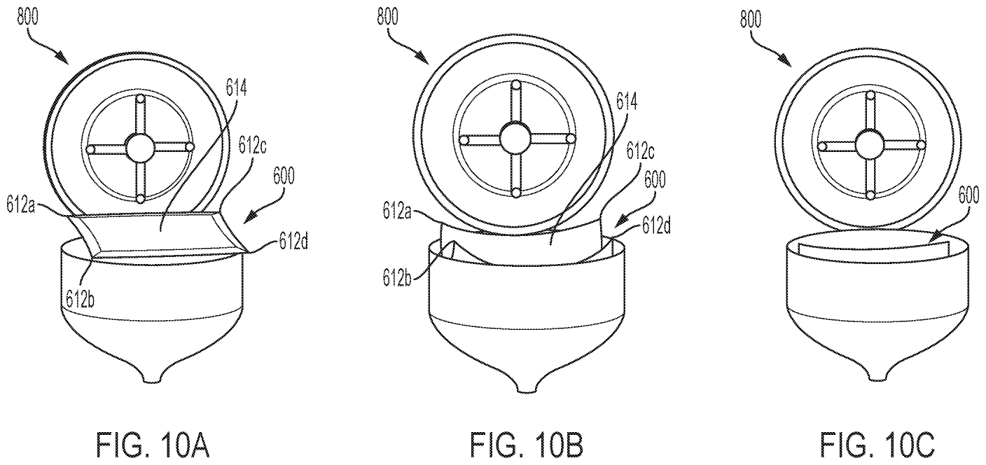

Reservoir 820 is substantially nut-shaped, having a width of an upper-section 828 substantially the same as a width of a middle-section 826, which drastically tapers to bottom section 822, where reservoir outlet 824 is located. By shaping reservoir 820 in a nut-shape taper, a shoulder having exact measurements for each package is not necessary, as the gradual taper could match packages of substantially any shape and size. For example, in FIGS. 9A and 9B, package 400 can be fit into reservoir 820, while in FIGS. 10A, 10B, and 10C, package 600 could be folded to fit into reservoir 820. When package 600 is folded to fit into reservoir 820, a user could push a center 614 of package 600, allowing corners 612a, 612b, 612c, and 612d to fold upwards along the walls of reservoir 820.

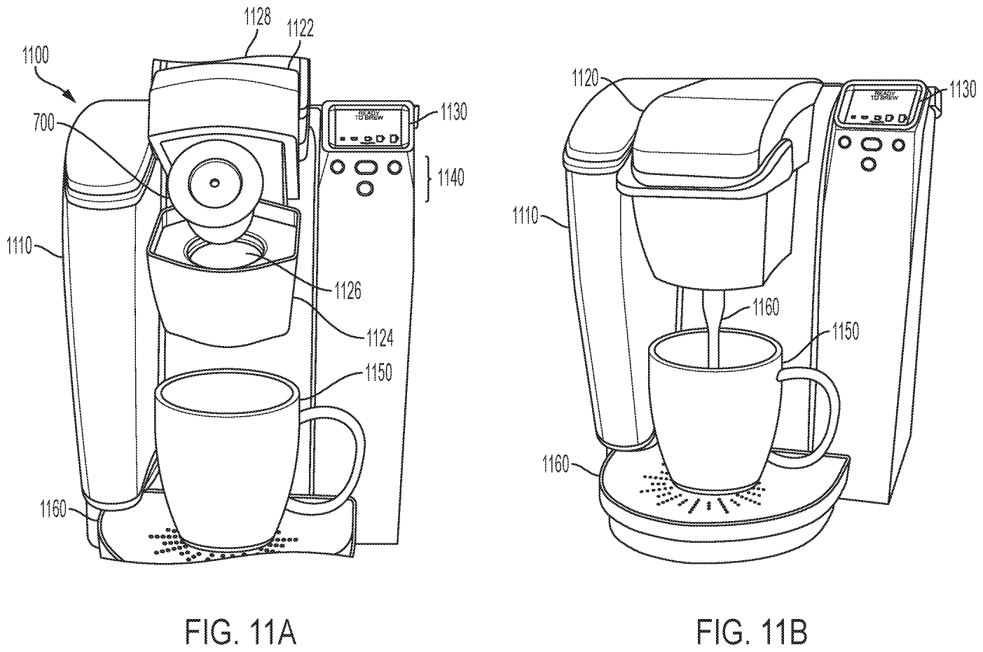

FIGS. 11A and 11B show an exemplary machine 1100 that could be used with a package holder containing a package, such as package holders 700 or 800. In some embodiments, machine 1100 could be configured to be substantially identical to a standard coffee machine that dispenses hot water at a given rate, such as one cup per 30 seconds, 60 seconds, 90 seconds, or even 120 seconds. In other embodiments, machine 1100 could be configured to dispense a plurality of beverages, for example a juice, a soda, and a water. In embodiments where machine 1100 is configured to dispense a plurality of beverages, machine 1100 is preferably configured to lastly dispense water, preferably water above 100 degrees Fahrenheit, such that the water is used to clean the interior of the package holder used in machine 1100.

Here, package holder 700 could be placed within dispenser 1120, which comprises cover 1122 and reservoir 1126, which can be opened and closed using lever 1128. A user typically places a dissolvable package, such as package 100 or package 300, within reservoir 720 of package holder 700, before placing package holder 700 within reservoir 1126 and closing cover 1122 using lever 1128. The user then places a cup 1150 under dispenser 1120 and selects an appropriate output of hot water to dispense using user interface 1130. Once the user instructs machine 1100 to dispense hot water with user interface 1130, hot water from water heater 1110 is dispensed through inlet hole 712 of package holder 700 to cover a portion of the dissolvable package, allowing the consumable material, such as coffee grounds, to mix with the hot water and exit the outlet hole 729 of package holder 700 so that mixed beverage 1160 flows into cup 1150. As the dissolvable package dissolves within package holder 700, the mixed beverage empties into cup 1150. Preferably, the rate of flow of water through package holder 700 is controlled such that the entirety of the dissolvable package dissolves during the pouring step, ensuring that package holder 700 is empty and cleaned (with the hot water dispensed at the end of the pouring step) so that package holder 700 is ready to use after the mixed beverage 1160 is poured into cup 1150.

Variables, such as the rate that a dissolvable packet dissolves, could be used to design the package holder 700 and/or machine 1100 to ensure that the dissolvable packet fully dissolves at the end of the pouring step. For example, repeated experiments could show that a package holder fully dissolves when fully submerged within a package holder for at least 15 seconds. Using that variable, machine 1100 could be configured to dispense a volume of hot water (e.g. the volume of upper reservoir 726 of package holder 700), wait 15 seconds, and then dispense the rest of the hot water requested by the user via user interface 1130. Other experiments could show that a package holder fully dissolves when submitted to a hot water flow rate of one cup every 60 seconds, but does not fully dissolve when submitted to a hot water flow rate of one cup every 45 seconds. A designer could then configure the machine 1100 to slow down its rate of flow to one cup of hot water every 60 seconds. Another experiment could show that a dissolvable package only fully dissolves when submitted to beverage temperatures above 130 degrees Fahrenheit. A designer could then configure machine 1100 to only dispense beverages (e.g. hot water) above 130 degrees Fahrenheit when in use, or when a user selects the dissolvable package option via user interface 1130.

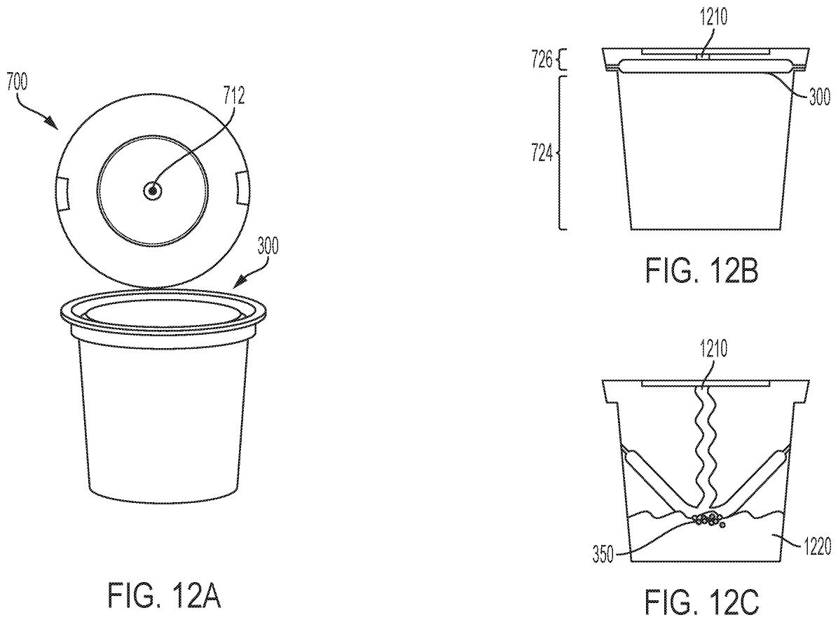

Dissolvable packets and/or package holders could be designed to allow for the same machine 1100 dispensing beverages in the same manner could result in different beverages being dispensed depending upon the dissolvable packet and/or package holder used. For example, in FIGS. 12A-12C, package holder 700 is used with dissolvable packet 300. Beverage 1210 is dispensed within upper reservoir 710, which causes a center portion of packet 300 to dissolve and collapse into two separate segments as the consumable material 350 mixes with beverage 1210 to create mixed beverage 1220. After the mixed beverage exits output hole 729, hot water could dispense (or continue to dispense, where beverage 1210 is hot water), to clean out package holder 700.

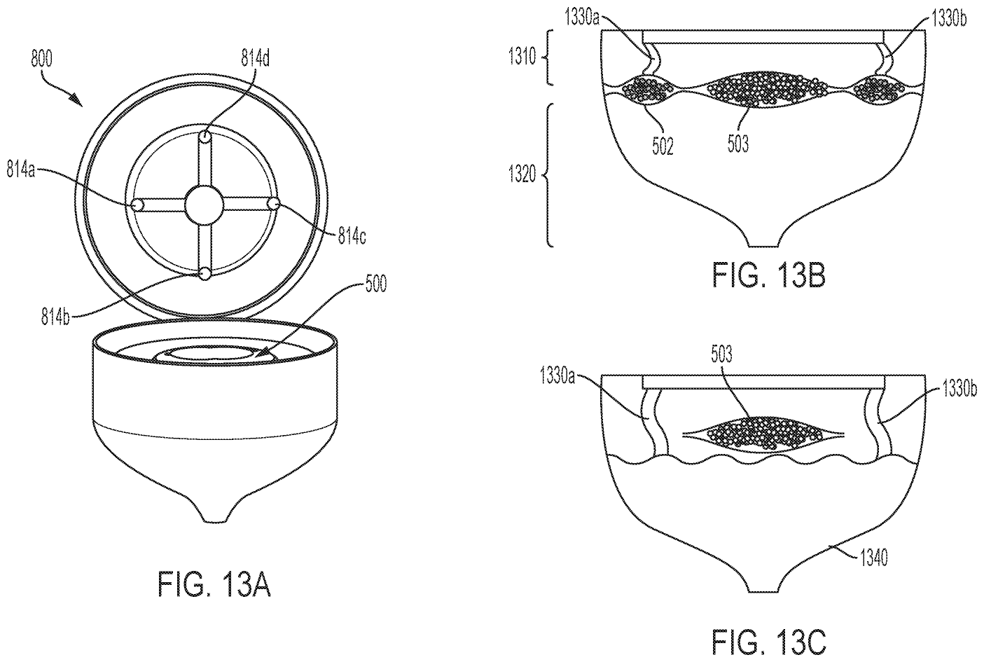

In FIGS. 13A-13C, package holder 800 is used with dissolvable packet 500, which could comprise coffee grounds in package section 502, and milk powder in package section 503. Dissolvable packet 500 is sized to sit such that an upper reservoir 1310 and a lower reservoir 1320 is formed within package holder 800 when dissolvable packet 300 is placed within the reservoir 820 of package holder 800. A beverage (e.g. hot water) is dispensed from four lower outlet ports 814a, 814b, 814c, and 814d, two of which are shown in FIG. 13B as beverage 1330a and 1330b. Since the dispensed beverage hits package section 502 first, package section 502 dissolves first, releasing coffee grounds which mix with beverages 1330a and 1330b to form mixed beverage 1340. This allows mixed coffee to first be dispensed through outlet port 824. Then, package section 503 dissolves, allowing the powdered milk to mix with the beverage such that mixed beverage 1340 is then primarily a milk mix. This configuration allows coffee to first be dispensed because the outlet ports are aimed to hit the package section containing coffee grounds, and then milk to be dispensed because the package section containing powdered milk dissolves later than the package section containing coffee grounds. Other embodiments could be used to ensure that one package section dissolves before another package section, such as by designing dissolvable packet 500 to have some walls (e.g. walls of package section 502) to be thinner than other walls (e.g. walls of package section 503), or by configuring package holder 800 to have outlet ports that ensure that some portions of dissolvable packet 500 are exposed to a dispensed beverage before other portions. As before, preferably a short time after dissolvable packet 500 completely dissolves, hot water is dispensed into package holder 800 to clean the interior of package holder 800 such that it is ready for use at the end of the pouring cycle.

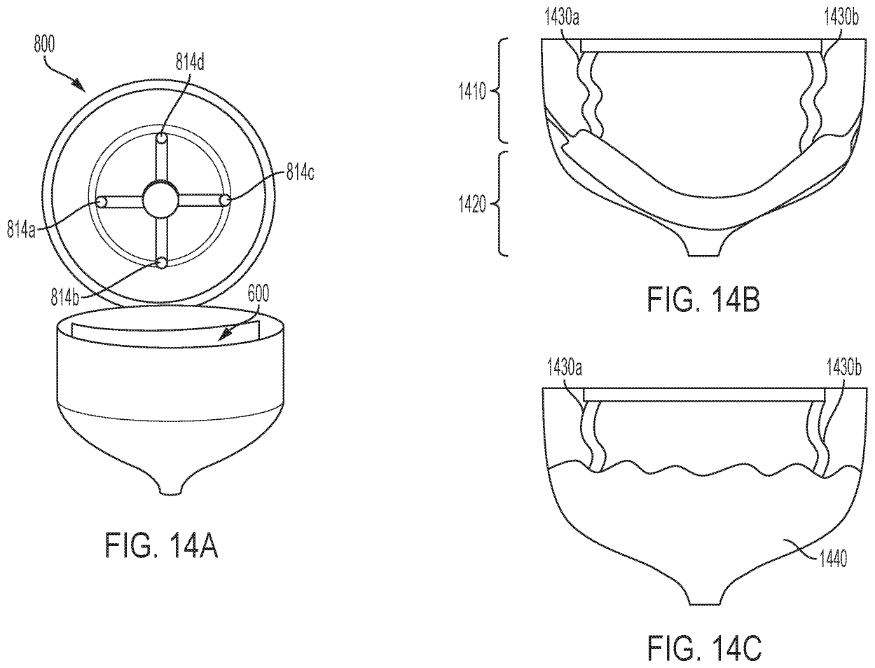

In FIGS. 14A-14C, package holder 800 is used with dissolvable packet 600, which is folded and/or crumpled to sit within a bottom portion 1420 of package holder 800. Beverages 1430a and 1430b are dispensed to immerse dissolvable packet 600 and such that the contents of dissolvable packet 600 mix with beverages 1430a and 1430b to form mixed beverage 1440, which is then dispensed through outlet port 824. As before, preferably a short time after dissolvable packet 600 completely dissolves, hot water is dispensed into package holder 800 to clean the interior of package holder 800 such that it is ready for use at the end of the pouring cycle.

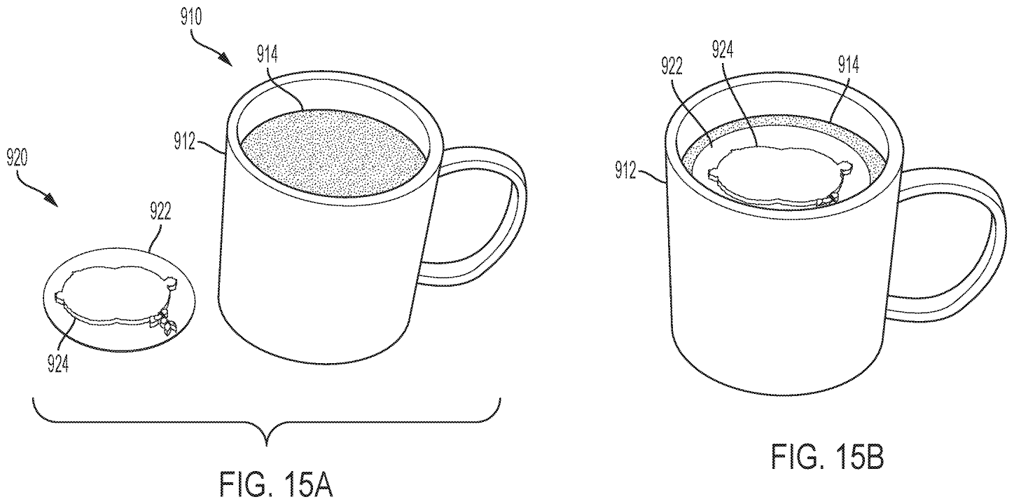

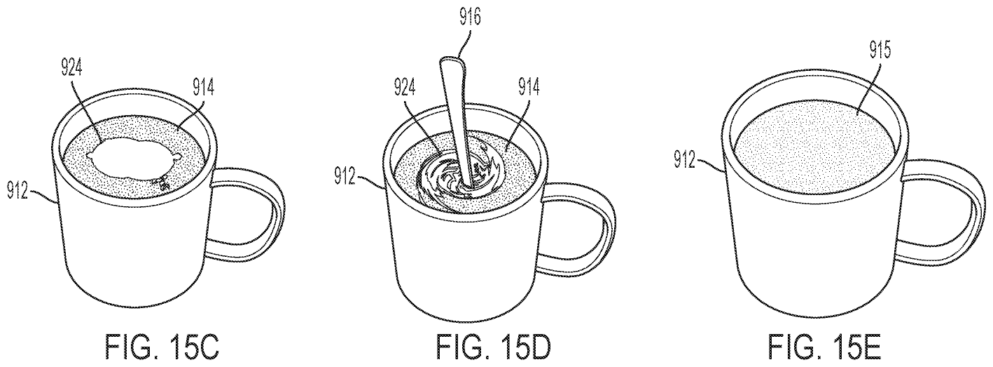

In FIGS. 15A-15E, a dissolvable, edible package 920 is disclosed that is used with a beverage 914 in cup 910. Beverage 914 is any consumable beverage, such as water, coffee or juice, that is held within cup walls 912. Package 920 has a dissolvable, edible sheet 922 having a dissolvable, edible logo 924 printed on sheet 922. Package 920 is constructed such that, when package 920 is placed on top of beverage 914, dissolvable, edible sheet 922 dissolves within beverage 914 before logo 924 dissolves within beverage 914. This could be designed in a plurality of ways, for example, by constructing sheet 922 of a material that dissolves faster than logo 924 (e.g. designing 922 to be of rice paper and logo 924 to be of an edible foam) or by constructing sheet 922 to be far thinner than logo 924 (e.g. sheet 922 is only 0.3 mm thick whereas logo 924 is 1.5 mm thick. As shown in FIG. 15C, when sheet 922 dissolves, preferably logo 924 is left floating on a surface of beverage 914. In some embodiments, logo 924 may dissolve gradually on its own into beverage 914, whereas in other embodiments, the dissolving process of logo 924 could be hastened by using a stirring device, such as spoon 916, to break apart logo 924 and accelerate the dissolving process. In FIG. 15E, the entirety of logo 924 has been dissolved into beverage 914 to formulate a new beverage 915 formulated of the elements of both beverage 914 and logo 924.

In some embodiments, package 920 could also comprise a second sheet that sandwiches another dissolvable material between the sheets, such as packages 100 or 300. In such embodiments, package 920 is constructed allow the second sheet to dissolve before logo 924, which would allow the dissolvable material sandwiched between the sheets to dissolve within beverage 914 before logo 924 dissolves within beverage 914. Such embodiments are preferably designed to allow for lower-placed sheets to dissolve first before upper-placed sheets, allowing for a layered dissolving process that starts from the bottom of the package and ends at the top of the package. Using such embodiments allows for a gradual dissolving process that is controlled by the rate at which the dissolvable materials used by the package dissolve within liquid beverages and/or by the thickness of such dissolvable materials (e.g. two materials made of the same dissolvable materials will dissolve at different rates as a function of their thickness).

The above description is given by way of example, and not limitation. For example, an embodiment of a machine 1100 could be used without a package holder, where reservoir 1126 is configured to have substantially the same inner dimensions and features as reservoir 720 or 820. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A package for preparing a beverage, the package comprising:
a first sheet comprising a first dissolvable material;
an adhesive disposed on an interior side of the first sheet for forming a first enclosed interior cavity of the package;
a first consumable material disposed within the at least one enclosed interior cavity of the package.

2. The package of claim 1, wherein each of the first sheet and the adhesive consist of consumable materials.

3. The package of claim 1, further comprising a rigid container;
wherein the rigid container comprises a second dissolvable material;
wherein the rigid container comprises a cavity that holds the first consumable material; and
wherein the sheet encloses an opening of the container to form the first enclosed interior cavity.

4. The package of claim 3, wherein the rigid container is further shaped to have an exterior surface that conforms to a preparation cavity of a beverage making machine that disposes water into the preparation cavity when making a beverage.

5. The package of claim 3, wherein the first dissolvable material comprises a consumable, dissolvable material different from the second dissolvable material.

6. The package of claim 1;
wherein the adhesive is disposed on an interior side of the first sheet to form both the first enclosed interior cavity of the package and a second enclosed interior cavity of the package;
wherein the second enclosed interior cavity of the package holds a second consumable material; and
wherein the first consumable material is different from the second consumable material.

7. The package of claim 1, further comprising a second sheet comprising a second dissolvable material;
wherein the second sheet separates the first enclosed interior cavity of the package from a second enclosed interior cavity of the package;
wherein the second enclosed interior cavity of the package holds a second consumable material; and
wherein the first consumable material is different from the second consumable material.

8. The package of claim 7, wherein the first dissolvable material dissolves at a different rate than the second dissolvable material.

9. The package of claim 1, wherein the first sheet comprises a dissolvable logo printed on a surface of the first sheet;

10. The package of claim 9, wherein the dissolvable logo comprises a second dissolvable material that dissolves at a slower rate than the first dissolvable material.

11. The package of claim 1, wherein the at least one consumable material comprises at least one product from the group consisting of a dissolvable coffee product, a protein powder, an additive, a creamer, a flavoring, a nutritional supplement, health supplement, medical supplement or a combination thereof.

12. The package of claim 1, wherein the sheet comprises a mixture of wood pulp, carboxymethyl cellulose and sodium carbonate.

13. The package of claim 1, wherein the adhesive is fabricated from a mixture of polyvinyl alcohol, propylene glycol, cellulose gum and glycerin.

14. The package of claim 1, wherein a thickness of the water dissolvable sheet is between 0.002 inch to 0.020 inch thick.

15. The package of claim 1, wherein a thickness of the water dissolvable sheet is between 0.039 inch and 0.157 inch thick.

16. The package of claim 1, wherein the at least one consumable material comprises an ingestible powder having a particle size of at most 0.1 inch in thickness in any direction.
